(19) United States
(12) Patent Application Publication
(10) Pub. No.: US 2025/0234279 A1
(43) Pub. Date: Jul. 17, 2025

(54) ARTIFICIAL INTELLIGNECE CAPABILITY SIGNALING FOR ACCESS POINTS

(71) Applicant: Cisco Technology, Inc., San Jose, CA (US)

(72) Inventors: Vishal S. Desai, San Jose, CA (US); Juan Carlos Zuniga, Montreal (CA); Federico Lovison, Fontanelle (IT)

(73) Assignee: Cisco Technology, Inc., San Jose, CA (US)

(21) Appl. No.: 19/024,827

(22) Filed: Jan. 16, 2025

Related U.S. Application Data
(60) Provisional application No. 63/621,486, filed on Jan. 16, 2024.

(51) Int. Cl. H04W 48/16; H04W 48/14; H04W 92/20

(52) U.S. Cl. CPC H04W 48/16; H04W 48/14; H04W 92/20

(57) ABSTRACT

Artificial intelligence capability signaling for devices such as Access Points (APs) may be provided. Exchanging artificial intelligence capabilities information can comprise determining artificial intelligence capabilities information. A composite Information Element (IE) containing the artificial intelligence capabilities information is generated, and the composite IE is sent to a device.

### RELATED APPLICATION

Under provisions of 35 U.S.C. § 119(e), Applicant claims the benefit of and priority to U.S. Provisional Application No. 63/621,486, filed Jan. 16, 2024, the disclosure of which is incorporated herein by reference in its entirety.

### TECHNICAL FIELD

The present disclosure relates generally to providing artificial intelligence capability signaling for devices such as Access Points (APs).

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for signaling artificial intelligence capabilities in accordance with aspects of the present disclosure.

FIG. 2 is a block diagram of a composite Information Element (IE) for signaling artificial intelligence capabilities in accordance with aspects of the present disclosure.

FIG. 3 is a block diagram of an overview IE for signaling artificial intelligence capabilities in accordance with aspects of the present disclosure.

FIG. 4 is a signal diagram of an association signal process for exchanging artificial intelligence capabilities information during association in accordance with aspects of the present disclosure.

FIG. 5 is a signal diagram of an Access Network Query Protocol (ANQP) signal process for exchanging artificial intelligence capabilities information in accordance with aspects of the present disclosure.

FIG. 6 is a flow chart of a method for signaling artificial intelligence capabilities in accordance with aspects of the present disclosure.

FIG. 7 is a block diagram of a computing device in accordance with aspects of the present disclosure.

FIG. 8 is a block diagram of a computing device in accordance with aspects of the present disclosure.

### DETAILED DESCRIPTION

### Overview

Artificial intelligence capability signaling for devices such as Access Points (APs) may be provided. Exchanging artificial intelligence capabilities information can comprise determining artificial intelligence capabilities information. A composite Information Element (IE) containing the artificial intelligence capabilities information is generated, and the composite IE is sent to a device.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

With the emergence of artificial intelligence functions, such as machine learning techniques, devices that facilitate and/or communicate via wireless networks can leverage said functions to provide increased network performance. For example, devices can provide higher network capacity and improved connectivity, resource management, troubleshooting, and so on by utilizing and otherwise enabling artificial intelligence functions. Network devices such as Access Points (APs) may progressively leverage and provide various artificial intelligence functions as the functions are developed and introduced, especially as Ultra High Reliability (UHR) WiFi-8 capable devices are implemented.

Artificial intelligence can be utilized for many different functions, including Channel access, link configurations, transmissions schemes, network optimization, load management, roaming, and so on. Additionally, artificial intelligence functions are presently being developed and enabled for use by devices. Determining which functions a specific device or network supports can therefore be difficult since devices may support different artificial intelligence functions. Thus, devices such as client devices may not know which artificial intelligence functions can be used when utilizing a network (e.g., communicating via an AP). Furthermore, different artificial intelligence models may be more efficient or otherwise appropriate to use for various use cases. Techniques for signaling (e.g., advertising) or otherwise communicating artificial intelligence capabilities are thus described herein to enable devices to determine which artificial intelligence functions are available. Signaling the artificial intelligence capabilities between devices can occur before and after association to an AP.

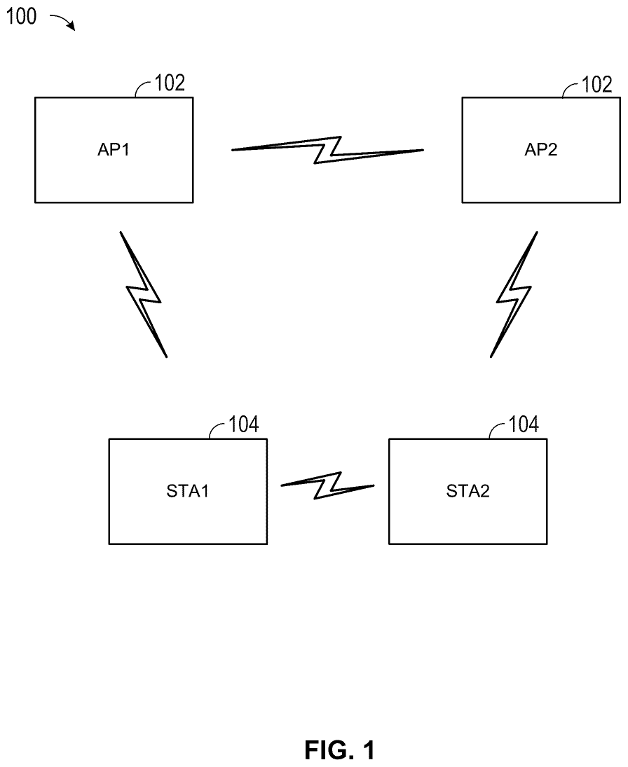

FIG. 1 is a block diagram of an operating environment 100 for signaling artificial intelligence capabilities. The operating environment 100 can include one or more APs 102 (e.g., AP1, AP2) and any number of Stations (STAs) 104 (e.g., STA1, STA2), such as client devices and other non-AP devices. The APs 102 can enable devices to access the network, such as by creating a Wireless Local Area Network (WLAN). The STAs 104 can be any device that connects to the wireless network (e.g., via the APs 102), such as a smart phone, a tablet, a personal computer, a server, an Internet-of-Things device, and the like. For example, once a STA 104 associates with an AP 102, the STA 104 can exchange data with other systems on the network via the AP 102. There may be a different number of devices in the operating environment 100 in further embodiments, including APs 102, STAs 104, controllers, and/or the like.

In certain embodiments, the APs 102, the STAs 104, and/or the like can use artificial intelligence (e.g., machine learning) techniques. In general, machine learning is concerned with the design and the development of techniques that take data (e.g., network statistics, performance indicators) as input, and recognize complex patterns in the data. One common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x +b*y+c and the cost function would be the number of misclassified points. The learning process then operates by adjusting the parameters a, b, c such that the number of misclassified points is minimal. After this optimization phase (or learning phase), the model M can be used to classify new data points. Often, M is a statistical model, and the cost function is inversely proportional to the likelihood of M, given the input data.

In various implementations, the APs 102, the STAs 104, and/or the like may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. Unsupervised techniques do not require a training set of labels. While a supervised learning model may look for previously seen patterns that have been labeled as such, an unsupervised model may instead look to whether there are sudden changes or patterns in the behavior of the attributes. Semi-supervised learning models are a mixed approach that use a reduced set of labeled training data.

Example machine learning techniques that the APs 102, the STAs 104, and/or other devices can employ may include Nearest Neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), Support Vector Machines (SVMs), Generative Adversarial Networks (GANs), Long Short-Term Memory (LSTM), logistic or other regression, Markov models or chains, Principal Component Analysis (PCA) (e.g., for linear models), Singular Value Decomposition (SVD), Multi-Layer Perceptron (MLP) Artificial Neural Networks (ANNs) (e.g., for non-linear models), replicating reservoir networks (e.g., for non-linear models, typically for timeseries), random forest classification, and/or the like.

In further implementations, the APs 102, the STAs 104, and/or the like are capable of using one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, Generative Adversarial Networks (GANs), Large Language Models (LLMs), other transformer models, and/or the like.

The APs 102 and the STAs 104 may signal their respective artificial intelligence capabilities to the other devices, for example so devices know which capabilities can be utilized. The communications to signal the artificial intelligence capabilities can be AP-to-AP (e.g., between AP1 102 and AP2 104), STA-to-STA (e.g., between STA1 104 and STA2 104), and/or AP-to-STA (e.g., between AP1 102 and STA1 104). The devices can exchange the artificial intelligence capabilities via one more techniques as described herein, such as using a composite Information Element (IE), existing IEs, a simplified IE, a query process, Access Network Query Protocol (ANQP), Inter-AP Protocol (IAPP), constellation parameters, and/or the like.

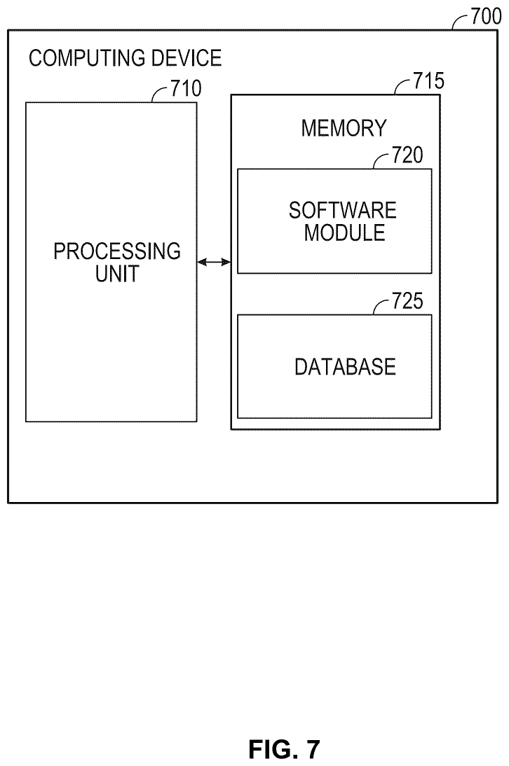

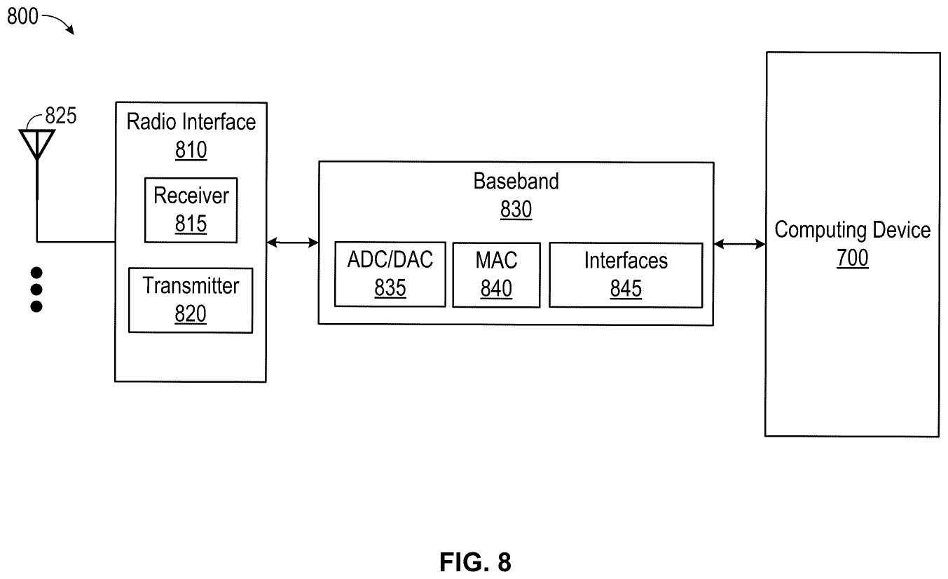

The elements described above of the operating environment 100 (e.g., the APs 102, the STAs 104, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 7 and 8, the elements of the operating environment 100 may be practiced in a computing device 700 and/or communications device 800.

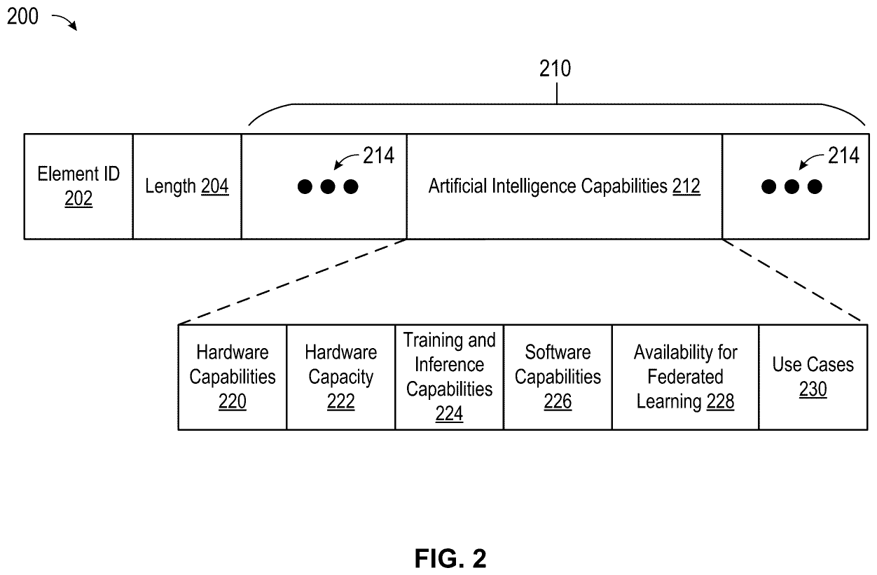

FIG. 2 is a block diagram of a composite IE 200 for signaling artificial intelligence capabilities. In embodiments, the composite IE 200 is a structured data element used to convey multiple pieces of information in a compact and efficient manner within the network's protocol. The composite IE 200 is a container that combines several individual elements or fields into a cohesive unit, for example to simplify transmission, improve organization, improve resource usage, and/or the like. The APs 102, the STAs 104, and/or the like can utilize the composite IE 200 to signal its respective artificial intelligence capabilities.

The composite IE 200 includes an element Identifier (ID) field 202, a length field 204, and a body 210. The composite IE 200 can include another combination of fields in other embodiments, however. The element ID field 202 indicates the type of the composite IE 200 or otherwise indicates the data the composite IE 200 contains. Thus, a receiving device can use the element ID field 202 identify that the composite IE 200 includes information associated with artificial intelligence capabilities of the sending device. The length field 204 indicates the length of the body 210 and any other fields of the payload portion of the composite IE 200. The body 210 includes the data of the composite IE 200, including the artificial intelligence capabilities information. The body 210 can include an artificial intelligence capabilities field 212 and zero or more additional fields as indicated by the ellipses 214. For example, the composite IE 200 can include sub-IEs that contain information derived based on artificial intelligence functions for individual use-cases and solutions.

The artificial intelligence capabilities field 212 can include one or more sub-fields. For example, in the illustrated embodiment, the artificial intelligence capabilities field 212 includes a hardware capabilities field 220, a hardware capacity field 222, a training and inference capabilities field 224, a software capabilities field 226, an availability for federated learning field 228, and a use cases field 230. The hardware capabilities field 220 can include data about the hardware of the associated device, such as information about the Central Processing Unit (CPU), the Graphics Processing Unit (GPU), the Random Access Memory (RAM), and/or the storage. The hardware information in the hardware capabilities field 220 may be used to identify the hardware capabilities and limitations for performing artificial intelligence techniques. The hardware capacity field 222 can include data indicating the availability of the hardware components for performing artificial intelligence techniques. For example, the hardware capacity information in the hardware capacity field 222 can indicate the availability (e.g., resources available, portion of the component that can be dedicated) of the CPU, the GPU, the RAM, and/or the storage. The device receiving the composite IE 200 can thus determine the portions of hardware that can be allocated to performing artificial intelligence techniques.

The training and inference capabilities field 224 can include data about training capabilities and/or inference capabilities. The training capability information can indicate the training processes the device sending the composite IE 200 is capable of. For example, the training capability information can include the types of artificial intelligence techniques the device can train, the GPU tokens or otherwise a measure of the computational resources allocated for performing the training, and/or the like. Similarly, the inference capability information can include the type of artificial intelligence techniques for inference processes, including making predictions and/or decisions based on input data. For example, the inference capability information can include the types of artificial intelligence techniques the device can use for inference determinations, the GPU tokens or otherwise a measure of the computational resources allocated for performing the inference determinations, and/or the like.

The software capabilities field 226 can include data indicating the artificial intelligence techniques (e.g., models, model families) that can be supported by the associated device. For example, the software capability information can indicate the model families that can be supported by the artificial intelligence stack of the device sending the composite IE 200. Thus, the device receiving the composite IE 200 can identify the available artificial intelligence techniques. The availability for federated learning field 228 includes federated learning capability information indicating whether the device is available for decentralized artificial intelligence training and/or other decentralized processing techniques. The use cases field 230 includes use case information associated with the use cases for the available artificial intelligence techniques. For example, the use cases field 230 includes a mapping of use cases to models and/or model structures.

The APs 102, the STAs 104, and/or the like can send the composite IE 200 to a destination device to signal the respective artificial intelligence capabilities by embedding the composite IE 200 within beacon frames, probe responses (e.g., an Unsolicited Broadcast Probe Response (UBPR), a unicast probe response), action frames, and/or the like. Thus, existing IEs and/or vendor-specific IEs can be enhanced to append the artificial intelligence capabilities information. In other embodiments, the APs 102, the STAs 104, and/or the like can send the composite IE 200 to a destination device directly, such as in a new frame, without embedding the composite IE 200 in an existing frame.

When an AP 102 includes the composite IE 200 in a beacon frame, the AP 102 provides its artificial intelligence capabilities information, in addition to the network information, to any device trying to connect to the network and/or devices already associated. Thus, the STAs 104 can receive the artificial intelligence capabilities information from the APs 102 via beacon frames comprising a composite IE 200. In some example implementations, the APs 102 can share artificial intelligence capabilities information, via multiple composite IEs 200 for example, for multiple APs 102 (e.g., for the sending AP and the neighbor APs). An AP 102 can similarly include artificial intelligence capabilities information for itself and/or other APs 102 in a probe response frame after receiving a probe request from a STA 104.

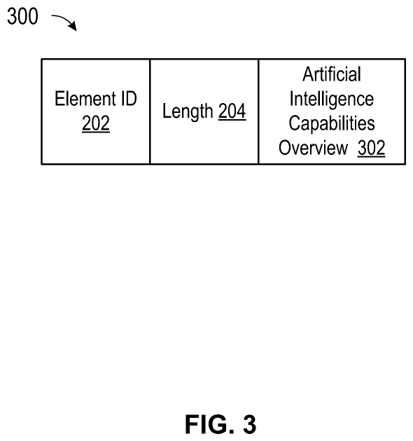

FIG. 3 is a block diagram of an overview IE 300 for signaling artificial intelligence capabilities The overview IE 300 can include basic information or a portion of the information less than the entire artificial intelligence capabilities information. The overview IE 300 may be utilized to manage the bandwidth consumed, airtime consumed, and/or the like when exchanging artificial intelligence capabilities between devices. For example, the overview IE 300 can be used in place of the composite IE 200, such as by embedding the overview IE 300 within beacon frames, probe responses, action frames, and/or the like.

The overview IE 300 includes an element ID field 202, a length field 204, and an artificial intelligence capabilities overview field 302. The overview IE 300 can include additional fields in further embodiments, but the fields may be limited to keep the overview IE 300 short to maintain its ability to manage the bandwidth or airtime consumed. The element ID field 202 indicates that the overview IE 300 includes overview artificial intelligence capabilities information. The length field 204 indicates the length of the artificial intelligence capabilities overview field 302. The artificial intelligence capabilities overview field 302 indicates the overview information. The sending device may limit the information included in the artificial intelligence capabilities overview field 302 by prioritizing information that is necessary for the receiving device to identify available artificial intelligence techniques and the availability to apply the techniques. For example, the artificial intelligence capabilities overview field 302 may include a limited use case list with only use cases the sending device expects to be used, details only for commonly used models, limited or no hardware information, etc.

When a device receives the overview information contained in the overview IE 300, the device can send a full artificial intelligence capabilities information request to request detailed information. The device that sent the overview IE 300 can respond to the request with a composite IE 200 or otherwise provide detailed artificial intelligence capabilities information.

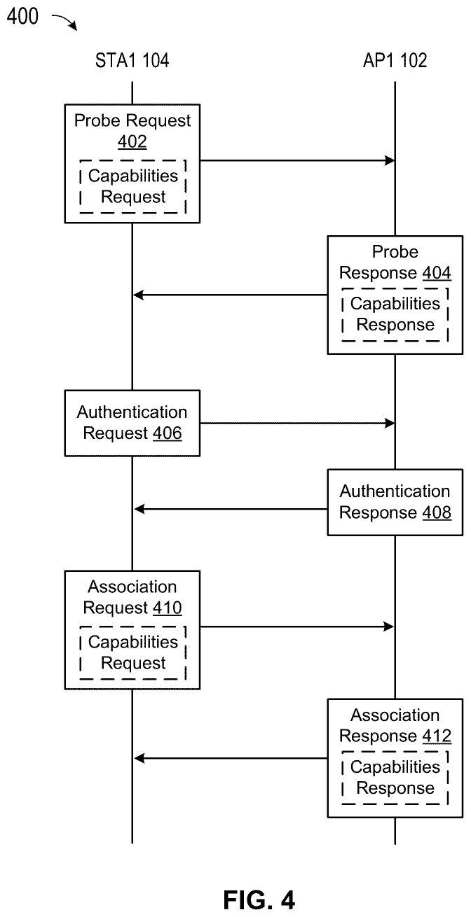

FIG. 4 is a signal diagram of an association signal process 400 for exchanging artificial intelligence capabilities information during association. During association, an STA 104 can query an AP 102 to receive artificial intelligence capabilities information, such as information pertaining to deployment centric use-cases.

The association signal process 400 includes the STA1 104 and the AP1 102 exchanging a probe request 402 and probe response 404, an authentication request 406 and authentication response 408, and an association request 410 and an association response 412. The STA1 104 can request artificial intelligence capabilities information via the probe request 402 or the association request 410. The AP1 102 can respond with artificial intelligence capabilities information. The capabilities request may be for specific information associated with deployment centric use-cases, and the response may contain said specific information. For example, the AP1 102 can enable necessary bits carrying information of stats and/or counters and generate an association response embedding this AI-ML information element.

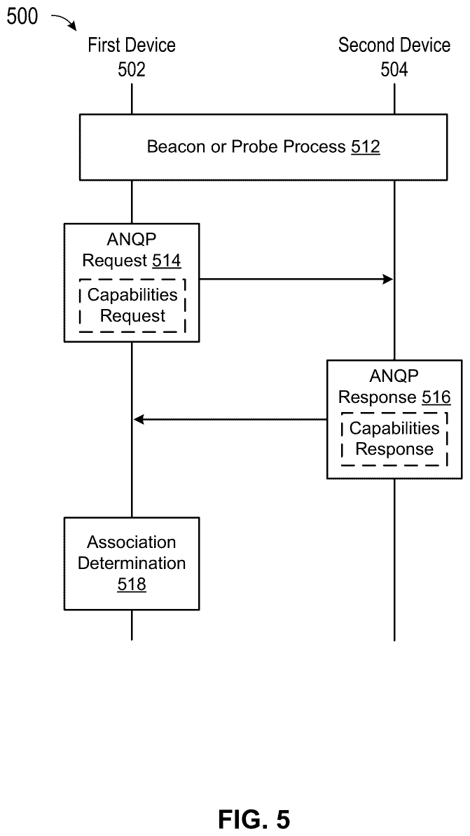

FIG. 5 is a signal diagram of an Access Network Query Protocol (ANQP) signal process 500 for exchanging artificial intelligence capabilities information. The ANQP signal process 500 can be an extension of the ANQP protocol or leverage the exchange process of the ANQP to enable the exchange of artificial intelligence capabilities information. Thus, devices can use the ANQP protocol to exchange artificial intelligence capabilities information when requesting information about the network, as ANQP is typically utilized. Or devices can use the ANQP protocol or an ANQP-like protocol specifically for exchanging artificial intelligence capabilities information. By using the ANQP signal process 500, devices can receive artificial intelligence capabilities information without associating to an AP 102.

The ANQP signal process 500 is performed between a first device 502 requesting artificial intelligence capabilities information and a second device 504 responding with the artificial intelligence capabilities information. The ANQP signal process 500 can be STA-to-AP, STA-to-STA, or AP-to-AP. Thus, the first device 502 and the second device 504 can be APs 102 and/or STAs 104.

The ANQP signal process 500 can begin with a beacon or probe process 512 to indicate the second device 504 supports ANQP signaling. In some example implementations, the beacon or probe process 512 includes the second device 504 sending a beacon indicating the second device 504 can support ANQP signaling. In other example implementations, the beacon or probe process 512 includes the first device 502 sending a probe request or some other signal to request the second device 504 to respond indicating ANQP capabilities and the second device 504 responding to indicate the second device 504 can support ANQP signaling. In some embodiments, the first device 502 may already be aware that the second device 504 can support ANQP signaling, and the beacon or probe process 512 can be skipped.

The first device 502 can then send an ANQP request 514 including a request for artificial intelligence capabilities information, and the ANQP request 514 can be a request using the Generic Advertisement Service (GAS). The ANQP request 514 may be a request querying the second device 504 for network information and artificial intelligence capabilities information, or the ANQP request 514 may be a request specifically querying the second device 504 for artificial intelligence capabilities information. The request can request an overview of the information, all the information, specific portions of the information, and/or the like. The second device 504 can respond to the ANQP request 514 with an ANQP response 516 including the requested artificial intelligence capabilities information. The requested artificial intelligence capabilities information can be an overview of the information, all the information, specific portions of the information, and/or the like.

The first device 502 can then perform an association determination 518 in certain embodiments. For example, when the first device 502 is a STA 104 and the second device 504 is an AP 102, the first device 502 can evaluate the ANQP response 516 with the artificial intelligence capabilities information to determine whether to associate with the second device 504. The first device 502 may determine to associate with the second device 504 based on available artificial intelligence techniques, available hardware for performing the techniques, and/or the like, or the first device 502 may determine to evaluate the artificial intelligence capabilities information of other APs 102.

In embodiments where a group of APs (e.g., AP1 102, AP2 102) are coordinating artificial intelligence computations among them, such as when the APs are acting as a local UHR constellation, the Inter-AP Protocol (IAPP) can serve as the transport mechanism for artificial intelligence capability signaling between APs 102. In certain embodiments, a composite IE 200 (and any necessary sub-IEs in the body 210) can represent the localized UHR constellations within a deployment by advertising the cluster ID and the method used to form constellation. For example, a local UHR constellation formed at a deployment and the method to form the constellation can be uniquely highlighted in the composite IE 200 (e.g., for association and/or roaming purposes of the STAs 104).

A sub-IE in the composite IE 200 can have fields containing model-specific parameters (e.g., the epsilon and minimum points, number of layers and nodes on a neural network). The sub-IE can also indicate the model and parameters used by the AP 102 to compute these predictions. A STA 104 receiving these predictions can use the information to make informed local decisions, such as selecting which AP 102 to associate with, among different neighbor APs 102. Additionally, when this information is exchanged between APs 102, it can facilitate the exchange of different performance metrics or models, enhancing coordination and optimization across the network.

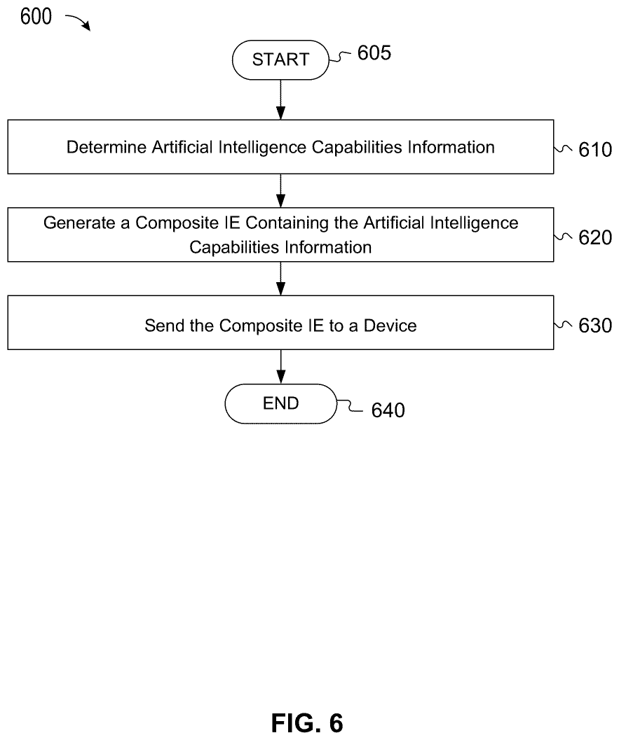

FIG. 6 is a flow chart of a method 600 for signaling artificial intelligence capabilities. The method 600 may begin at starting block 605 and proceed to operation 610. In operation 610, artificial intelligence capabilities information is determined. For example, any of the APs 102 or STAs can perform the method 600. AP1 102 will be referred to as performing the method 600 for simplicity of explanation herein, however. Thus, the AP1 102 determines artificial capabilities information, such as hardware information, hardware capacity information, training capability information, inference capability information, software capability information, federated learning capability information, use case information, and/or the like of the AP1 102.

In operation 620, a composite IE is generated containing the artificial intelligence capabilities information. For example, the AP1 102 generates a composite IE 102, including the artificial intelligence capabilities information in the body 210.

In operation 630, the composite IE is sent to a device. For example, the AP1 102 sends the composite IE 200 containing the artificial intelligence capabilities information to a device (e.g., the AP2 102, the STA1 104, the STA2 104). In some embodiments, the method 600 further comprises receiving a request from the device to send the artificial intelligence capabilities information, and sending the composite IE to the device is in response the request.

The method 600 can further include generating an overview IE containing a portion of the artificial intelligence capabilities information, sending the overview IE to the device, and receiving a request for all the artificial intelligence capabilities information. Sending the composite IE to the device may be in response the request.

In some embodiments, sending the composite IE to the device is part of an association process of the device, such as described above with respect to FIG. 4. In further embodiments, sending the composite IE to the device comprises sending the composite IE via an Access Network Query Protocol (ANQP) response, such as described above with respect to FIG. 5. In other embodiments, sending the composite IE to the device comprises sending the composite IE via Inter-Access Point Protocol (IAPP). The method may conclude at ending block 640.

FIG. 7 is a block diagram of a computing device 700. As shown in FIG. 7, computing device 700 may include a processing unit 710 and a memory unit 715. Memory unit 715 may include a software module 720 and a database 725. While executing on processing unit 710, software module 720 may perform, for example, processes for signaling artificial intelligence capabilities with respect to FIGS. 1-6. Computing device 700, for example, may provide an operating environment for the APs 102, the STAs 104, and the like. The APs 102, the STAs 104, and the like may operate in other environments and are not limited to computing device 700.

Computing device 700 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 700 may comprise any computer operating environment, such as hand-held devices, multiprocessor systems, microprocessor-based or programmable sender electronic devices, minicomputers, mainframe computers, and the like. Computing device 700 may also be practiced in distributed computing environments where tasks are performed by remote processing devices. The aforementioned systems and devices are examples, and computing device 700 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 700 on the single integrated circuit (chip).

FIG. 8 illustrates an implementation of a communications device 800 that may implement one or more of the APs 102, the STAs 104, etc., of FIGS. 1-6. In various implementations, the communications device 800 may comprise a logic circuit. The logic circuit may include physical circuits to perform operations described for one or more of the APs 102, the STAs 104, etc., of FIGS. 1-6, for example. As shown in FIG. 8, the communications device 800 may include one or more of, but is not limited to, a radio interface 810, baseband circuitry 830, and/or the computing device 700.

The communications device 800 may implement some or all of the structures and/or operations for the APs 102, the STAs 104, etc., of FIGS. 1-6, storage medium, and logic circuit in a single computing entity, such as entirely within a single device. Alternatively, the communications device 800 may distribute portions of the structure and/or operations using a distributed system architecture, such as a client station server architecture, a peer-to-peer architecture, a master-slave architecture, etc.

A radio interface 810, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 810 may include, for example, a receiver 815 and/or a transmitter 820. The radio interface 810 may include bias controls, a crystal oscillator, and/or one or more antennas 825. In additional or alternative configurations, the radio interface 810 may use oscillators and/or one or more filters, as desired.

The baseband circuitry 830 may communicate with the radio interface 810 to process, receive, and/or transmit signals and may include, for example, an Analog-To-Digital Converter (ADC) for down converting received signals with a Digital-To-Analog Converter (DAC) 835 for up converting signals for transmission. Further, the baseband circuitry 830 may include a baseband or PHYsical layer (PHY) processing circuit for the PHY link layer processing of respective receive/transmit signals. Baseband circuitry 830 may include, for example, a MAC processing circuit 840 for MAC/data link layer processing. Baseband circuitry 830 may include a memory controller for communicating with MAC processing circuit 840 and/or a computing device 700, for example, via one or more interfaces 845.

In some configurations, PHY processing circuit may include a frame construction and/or detection module, in combination with additional circuitry such as a buffer memory, to construct and/or deconstruct communication frames. Alternatively or in addition, MAC processing circuit 840 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
determining artificial intelligence capabilities information;
generating a composite Information Element (IE) containing the artificial intelligence capabilities information; and
sending the composite IE to a device.

2. The method of claim 1, wherein sending the composite IE to the device comprises:
embedding the composite IE in any one of a beacon, a probe response, or an action frame; and
sending the beacon, the probe response, or the action frame to the device.

3. The method of claim 1, further comprising:
receiving a request from the device to send the artificial intelligence capabilities information, wherein sending the composite IE to the device is in response the request.

4. The method of claim 1, further comprising:
generating an overview IE containing a portion of the artificial intelligence capabilities information;
sending the overview IE to the device; and
receiving a request for all the artificial intelligence capabilities information, wherein sending the composite IE to the device is in response the request.

5. The method of claim 1, wherein sending the composite IE to the device is part of an association process of the device.

6. The method of claim 1, wherein sending the composite IE to the device comprises sending the composite IE via an Access Network Query Protocol (ANQP) response.

7. The method of claim 1, wherein sending the composite IE to the device comprises sending the composite IE via Inter-Access Point Protocol (IAPP).

8. The method of claim 1, wherein the artificial intelligence capabilities information comprises any one of (i) hardware information, (ii) hardware capacity information, (iii) training capability information, (iv) inference capability information, (v) software capability information, (vi) federated learning capability information, (vii) use case information, or (viii) any combination of (i)-(vii).

9. A system comprising:
a memory storage; and
a processing unit coupled to the memory storage, wherein the processing unit is operative to:
determine artificial intelligence capabilities information;
generate a composite Information Element (IE) containing the artificial intelligence capabilities information; and
send the composite IE to a device.

10. The system of claim 9, wherein sending the composite IE to the device comprises to:
embed the composite IE in any one of a beacon, a probe response, or an action frame; and
send the beacon, the probe response, or the action frame to the device.

11. The system of claim 9, the processing unit being further operative to:
receive a request from the device to send the artificial intelligence capabilities information, wherein to send the composite IE to the device is in response the request.

12. The system of claim 9, the processing unit being further operative to:
generate an overview IE containing a portion of the artificial intelligence capabilities information;
send the overview IE to the device; and
receive a request for all the artificial intelligence capabilities information, wherein to send the composite IE to the device is in response the request.

13. The system of claim 9, wherein to send the composite IE to the device comprises to send the composite IE via an Access Network Query Protocol (ANQP) response.

14. The system of claim 9, wherein the artificial intelligence capabilities information comprises any one of (i) hardware information, (ii) hardware capacity information, (iii) training capability information, (iv) inference capability information, (v) software capability information, (vi) federated learning capability information, (vii) use case information, or (viii) any combination of (i)-(vii).

15. A non-transitory computer-readable medium that stores a set of instructions which when executed perform a method executed by the set of instructions comprising:
determining artificial intelligence capabilities information;
generating a composite Information Element (IE) containing the artificial intelligence capabilities information; and
sending the composite IE to a device.

16. The non-transitory computer-readable medium of claim 15, wherein sending the composite IE to the device comprises:
embedding the composite IE in any one of a beacon, a probe response, or an action frame; and
sending the beacon, the probe response, or the action frame to the device.

17. The non-transitory computer-readable medium of claim 15, the method executed by the set of instructions further comprising:
receiving a request from the device to send the artificial intelligence capabilities information, wherein sending the composite IE to the device is in response the request.

18. The non-transitory computer-readable medium of claim 15, the method executed by the set of instructions further comprising:
generating an overview IE containing a portion of the artificial intelligence capabilities information;
sending the overview IE to the device; and
receiving a request for all the artificial intelligence capabilities information, wherein sending the composite IE to the device is in response the request.

19. The non-transitory computer-readable medium of claim 15, wherein sending the composite IE to the device comprises sending the composite IE via an Access Network Query Protocol (ANQP) response.

20. The non-transitory computer-readable medium of claim 15, wherein sending the composite IE to the device comprises sending the composite IE via Inter-Access Point Protocol (IAPP).
